(19) United States
(12) Patent Application Publication
(10) Pub. No.: US 2026/0176041 A1
(43) Pub. Date: Jun. 25, 2026

(54) MULTILAYER BARRIER FILM, METHOD FOR MANUFACTURING MULTILAYER BARRIER FILM, AND PAPER OR PAPERBOARD BASED PACKAGING MATERIAL COMPRISING MULTILAYER BARRIER FILM

(71) Applicant: Stora Enso OYJ, Helsinki (FI)

(72) Inventors: Anna Kauppi, Lappeenranta (FI); Isto Heiskanen, Imatra (FI); Kaj Backfolk, Lappeenranta (FI)

(73) Assignee: Stora Enso OYJ, Helsinki (FI)

(21) Appl. No.: 19/128,841

(22) PCT Filed: Nov. 8, 2023
(86) PCT No.: PCT/IB2023/061258

§ 371 Date: May 9, 2025

(30) Foreign Application Priority Data
Nov. 11, 2022 (SE) 2230362-2

(51) Int. Cl. B65D 65/40; B32B 5/02; B32B 29/02

(52) U.S. Cl. CPC B65D 65/40; B32B 5/02; B32B 29/02; B32B 2255/02; B32B 2255/26; B32B 2307/546; B32B 2307/718; B32B 2307/7244; B32B 2439/00; B65D 2565/387

(57) ABSTRACT

The present invention relates to a multilayer barrier film for a paper or paperboard packaging material, said barrier film comprises a first layer comprising a furnish comprising at least 70 wt-% of highly refined cellulose based on the total fiber content of the first layer, a second layer comprising a furnish comprising cellulosic fibers and less than 50 wt-% of highly refined cellulose based on the total fiber content of the second layer wherein the multilayer barrier film has an air permeance above 1000 pm/Pas and a tear index GM above 4.5. The present invention further relates to a paper and paperboard based packaging material comprising such multilayer barrier film and to methods for manufacturing such multilayer barrier film.

### TECHNICAL FIELD

The present disclosure relates to a multilayer barrier film for a paper or paperboard packaging material. The present invention further relates to a paper and paperboard based packaging material comprising such multilayer barrier film and to methods for manufacturing such multilayer barrier film.

### BACKGROUND

Coating of paper and paperboard with plastics is often done to combine mechanical properties of the paperboard with barrier and sealing properties of a plastic film. Paperboard provided with even a relatively small amount of a suitable plastic material can provide the properties needed to make the paperboard suitable for many demanding applications, for example as liquid packaging board. In liquid packaging board, polyolefin coatings are frequently used as liquid barrier layers, heat sealing layers and adhesives.

In many cases, gas, light and moisture barrier properties of the polymer coated paperboard are still insufficient. Therefore, in order to ensure acceptable gas, light and moisture barrier properties, the polymer coated paperboard is often provided with one or more layers of aluminum foil. However, the addition of polymer and aluminum layers add significant costs and makes recycling of the materials more difficult. Also, due to its high carbon footprint there is a wish to replace aluminum foils in packaging materials in general, and in liquid packaging board in particular.

More recently, microfibrillated cellulose (MFC) films and coatings have been developed, in which fibrillated cellulosic fibrils have been dispersed e.g. in water and thereafter re-organized and rebonded together to form a dense film with excellent gas barrier properties. Unfortunately, dense MFC films and extensive fibrillation and densification processes reduces the mechanical properties of MFC films, which makes their impact on stiffness in paper or paperboard laminates less beneficial as well as converting more challenging. A densification process using finer fibers and fibrils leads to longer dewatering times and higher risk of variations in air permeance.

Thus, there remains a need for improved solutions to replace plastic films and aluminum foils in packaging materials, while maintaining high liquid and barrier properties. At the same time, there is a need to replace the plastic films and aluminum foils with renewable films that improves the mechanical properties of the paper or paperboard laminate.

### DESCRIPTION OF THE INVENTION

It is an object of the present disclosure to provide an alternative to the plastic films and aluminum foils commonly used as barrier films for providing liquid and oxygen barrier properties in packaging materials, such as liquid packaging board.

It is a further object of the present disclosure to provide a multilayer barrier film for paper or paperboard based packaging materials, which improves the mechanical properties of the materials.

It is a further object of the present disclosure, to provide a multilayer barrier film comprising highly refined cellulose, which has improved barrier properties and improved strength properties.

It is a further object of the present invention to be able to increase the production speed of the multilayer barrier film and still be able to produce a film with good barrier properties.

The above-mentioned objects, as well as other objects as will be realized by the skilled person in the light of the present disclosure, are achieved by the various aspects of the present disclosure.

According to a first aspect illustrated herein, there is provided a multilayer barrier film for a paper or paperboard packaging material, said barrier film comprises
a first layer comprising a furnish comprising at least 70 wt-% of highly refined cellulose based on the total fiber content of the first layer,
a second layer comprising a furnish comprising cellulosic fibers and less than 50 wt-% of highly refined cellulose based on the total fiber content of the second layer
and wherein the multilayer barrier film has an air permeance above 1000 μm/Pas and a geometric mean (GM) tear index above 4.5.

It may be preferred that the multilayer barrier film has an air permeance above 1000 μm/Pas, preferably above 2000 μm/Pas or even more preferred above 5000 pm/Pas. The air permeance is measured according to ISO 5636-1 using L&W Code 168 air permeance tester (pm/Pa*s at 20 kPa). The higher air permeance the more open film structure, i.e. decreased oxygen barrier properties. The barrier film preferably has the mentioned air permeance on at least one side of the multilayer barrier film, i.e. either on the top side (ts) or the back side (bs), preferably on the top side. This air permeance value of the multilayer barrier film before addition of any eventual polymer layers.

The multilayer barrier film as a tear index GM above 4.5, preferably above 5.0 and even more preferred above 5.5. The increased tear index GM value of the film shows that the multilayer barrier film has good mechanical properties and can handle mechanical process steps such as converting, coating and calendering without breaking and thus destroying the barrier properties of the film. This is the value of the multilayer barrier film before addition of any eventual polymer layers.

The tear index is calculated from the tearing resistance. The tearing resistance is measured according to ISO 1974. The tearing resistance is determined in CD and MD and tear index is obtained by dividing the tearing resistance in respective direction with the grammage of the film. The geometric mean (GM) tear index is calculated based on the tear index in MD and CD according to (MD×CD)^{1/2}.

The invention is based on the surprising realization that it was possible to produce a multilayer barrier film with good strength properties at high production speed. It was also surprising that the uncoated multilayer barrier film does not need to have good oxygen barrier properties but after application of a polymer coating, especially a water soluble polymer, the coated multilayer barrier film will have excellent barrier properties. Consequently, the multilayer barrier film according to the invention is suitable to coat and to form a coated multilayer barrier film with excellent oxygen barrier properties.

The first layer of the multilayer barrier film preferably forms the top side of the film and the second layer of the multilayer barrier film preferably forms the bottom side of the film. The first and second layer are preferably attached to each other, i.e. there is preferably no layers between the first and second layer.

The multilayer barrier film may further comprise a third layer wherein said third layer comprises a polymer forming a polymer coated multilayer barrier film. The polymer of the third layer is preferably a water soluble polymer. It is preferred to use polyvinyl alcohol (PVOH), polyurethane, styrene polyacrylates, ethylene acrylic acid, polysaccharides such as starch, starch alignate, hemicellulose, chitosan, cellulose or derivatives of mentioned polysaccharides and mentioned polymers. Polyvinyl alcohol (PVOH) is the preferred polymer which has shown to give excellent barrier properties.

It is preferred that the third layer is coated onto said first layer. It has been found that improved barrier properties can be achieved when a polymer coating is coated on the first layer, i.e. on the top side of the multilayer barrier film. The coated may be added in-line or on-line.

The multilayer barrier film comprising the third layer, i.e. the polymer coated multilayer barrier film preferably has an oxygen transmission rate (OTR), measured according to the standard ASTM F1927-20 at 50% relative humidity and 23° C., of less than 5 cc/m²/24 h, preferably below 3 cc/m²/24 h and even more preferred below 1 cc/m²/24 h. It has been found that a multilayer barrier film with very good oxygen barrier properties can be achieved.

The multilayer barrier film of the present invention is suitable for applying a polymer coating, preferably a water soluble polymer coating. The suspension or dispersion comprising said water soluble polymer coating, preferably PVOH, preferably has a water retention value above 50 gsm, preferably above 100 gsm, even more preferred above 125 gsm, more preferably above 150 μm measured according to TAPPI T701 pm-01. The high water retention value means that the suspension or dispersion will release more water to the barrier film. The barrier film of the present invention is surprisingly suitable for such polymer coating since it is less sensitive to wetting and water penetration compared to e.g. a pure HRC film.

The grammage of the third layer is preferably below 15 gsm, preferably between 0.5-10 gsm and even more preferred between 1.5-5 gsm. It has been found that it is sufficient to add small amounts of polymer in the third layer and still be able to produce a multilayer barrier film with excellent barrier properties. The third layer may be a multilayer comprising two or more thin polymer layers.

The first layer of the multilayer barrier film preferably comprises between 70-100 wt-%, preferably between 80-95 wt-% or even more preferred between 85-95 wt-% of highly refined cellulose based on the total fiber content of the first layer. The first layer of the multilayer barrier film comprises high amounts of highly refined cellulose which will improve the barrier properties and the strength of the film.

The second layer of the multilayer barrier film preferably comprises between 5-50 wt-%, preferably between 10-40 wt-% or even more preferred between 15-30 wt-% of highly refined cellulose based on the total fiber content of the second layer. The second layer of the multilayer barrier film comprises lower amounts of highly refined cellulose. By decreasing the amount of highly refined cellulose it is possible to increase the dewatering speed and thus the production speed of the film. It has been found that it is sufficient to decrease the amount of the highly refined cellulose in the multilayer barrier film and still be able to produce a film with barrier properties.

The highly refined cellulose (HRC) is preferably produced from a cellulose pulp suspension by subjecting the pulp to refining. The highly refined cellulose comprises cellulose particles, fibers or fibrils. The HRC can be produced from wood cellulose fibers, both from hardwood or softwood fibers. It can also be made from microbial sources, agricultural fibers such as wheat straw pulp, bamboo, bagasse, or other non-wood fiber sources. It can be made from pulp, including pulp from virgin fiber, e.g. mechanical, chemical and/or thermomechanical pulps. It can also be made from broke or recycled paper.

The highly refined cellulose preferably has a Schopper Riegler value above 70, as determined by standard ISO 5267-1, even more preferably above 80, and even more preferred above 85.

In some embodiments, the term highly refined cellulose as used herein refers to a cellulose pulp which has been subjected to considerable refining, but not to the extent that all of the cellulose pulp will pass through a 200 mesh screen (equivalent hole diameter 76 μm) of a conventional laboratory fractionation device (SCAN-CM 66:05). Preferably no more than 60% of the highly refined cellulose will pass through a 200 mesh screen of a conventional laboratory fractionation device according to SCAN-CM 66:05. More preferably no more than 50% of the highly refined cellulose will pass through a 200 mesh screen of a conventional laboratory fractionation device according to SCAN-CM 66:05. In some embodiments, 5-60% and more preferably 10-50 wt % of the highly refined cellulose will pass through a 200 mesh screen of a conventional laboratory fractionation device according to SCAN-CM 66:05. Thus, the highly refined cellulose will comprise a mixture of finer particles and coarser particles. The size distribution of the particles in the highly refined cellulose may depend on the starting material and the refining processes used.

The highly refined cellulose is preferably microfibrillated cellulose (MFC). It is preferred that the microfibrillated cellulose has a Schopper Riegler (SR) value above 85, preferably above 90 and even more preferred above 95. The SR value is measured according to standard ISO 5267-1. It was found that even small amounts of MFC is sufficient to provide a barrier film with both improved barrier and strength properties. It is preferred to use native MFC.

Microfibrillated cellulose (MFC) shall in the context of the patent application mean a cellulose particle, fiber or fibril having a width or diameter of from 20 nm to 1000 nm.

Various methods exist to make MFC, such as single or multiple pass refining, pre-hydrolysis followed by refining or high shear disintegration or liberation of fibrils. One or several pre-treatment steps is usually required in order to make MFC manufacturing both energy efficient and sustainable. The cellulose fibers of the pulp used when producing MFC may thus be native or pre-treated enzymatically or chemically, for example to reduce the quantity of hemicellulose or lignin. The cellulose fibers may be chemically modified before fibrillation, wherein the cellulose molecules contain functional groups other (or more) than found in the original cellulose.

MFC can be produced from wood cellulose fibers, both from hardwood or softwood fibers. It can also be made from microbial sources, agricultural fibers such as wheat straw pulp, bamboo, bagasse, or other non-wood fiber sources. It can be made from pulp, including pulp from virgin fiber, e.g. mechanical, chemical and/or thermomechanical pulps. It can also be made from broke or recycled paper.

The second layer also comprises cellulosic fibers. It is preferred that the second layer comprises at least 50 wt-% of cellulosic fibers, based on the total fiber content of the second layer, preferably between 50-95 wt-%, preferably between 60-90 wt-% or even more preferred between 70-85 wt-%. The cellulosic fibers in the second layer preferably have a Schopper Riegler value between 15-45, as determined by standard ISO 5267-1, more preferably between 20-35. The cellulosic fibers are preferably fibers from either hardwood or softwood pulp. The cellulosic fibers can be a mixture of fibers from hardwood and softwood pulp. It may be preferred to use hardwood pulp since hardwood fibers has shown to improve the formation of the multilayer barrier film. The pulp can be pulp from virgin fiber, e.g. mechanical, semichemical, chemical, chemithermomechanical and/or thermomechanical pulps. It may be preferred that the cellulosic fibers are made from kraft pulp, more preferably bleached kraft pulp.

The cellulosic fibers are preferably gentle refined to improve the formation behavior, drainage and infiltration of highly refined cellulose into the film. The cellulosic fibers are preferably refined to the mentioned SR value using a specific edge load (SEL) below 1.5 J/m, preferably below 1.4 J/m and even more preferred below 1.3 J/m. It may be preferred to use different SEL values for different pulp types. For hardwood pulps, e.g. eucalyptus bleached kraft pulp and birch bleached kraft pulp, it is preferred to use a SEL value below 1.0 J/m, preferably below 0.75 J/m and more preferred lower than 0.65 J/m. For softwood pulp, such as pine or spruce bleached kraft pulps, it is preferred to use a SEL value below 1.5 J/m, preferably below 1.4 J/m and even more preferred below 1.3 J/m. The specific edge load theory is based on the idea that all the refining energy is transferred to the fibers by the bar edges during refining. The specific edge load describes the refining intensity and its calculated according to formula:

$$SEL = \frac{{P}_{tot} - {P}_{0}}{n \times {Z}_{r} \times {Z}_{st} \times l} = \frac{{P}_{net}}{n \times CLF} = \frac{{P}_{net}}{CEL}$$

where:
SEL specific edge load (J/m);
Pₜₒₜ total load power (kW);
P₀ no-load power (kW);
Pₙₑₜ net refining power (kW);
n rotation speed (revs/s);
Zᵣ number of rotor bars;
Zₛₜ number of stator bars;
l bar length (km);
CEL cutting edge length (km/s);
CLF cutting length factor (km/rev).

The furnish of the second layer comprising cellulosic fibers and less than 50 wt % of highly refined cellulose preferably has a dewatering time below 100 s/g. The second layer is made from said second furnish. It has been found that it is possible to use a furnish with very good dewatering properties and still be able to produce a multilayer film with good barrier properties. The low dewatering time will facilitate dewatering which makes it possible to increase the production speed.

The second layer of the multilayer barrier film preferably comprises 5-70 wt-% of broke based on the total fiber content of the furnish of the second layer, preferably between 10-50 wt-% and even more preferred between 20-40 wt-% t. With broke is meant re-used fibers from products that has not been used commercially, i.e. it is not recycled fibers. It may be preferred that the broke is made from the multilayer barrier film as described herein. The broke can be internal or external broke. The broke may also be wet broke or dry broke.

The multilayer barrier film preferably has a basis weight between 20-120 gsm, even more preferred between 25-90 gsm, more preferably between 30-70 gsm and most preferred between 35-60 gsm. This is the total basis weight of the multilayer barrier film, i.e. the total basis weight for all fiber based layers of the film.

It may be preferred that the multilayer barrier film comprises more than two layers. The multilayer barrier film may comprise of two, three, four, five, six or even more layers. The layers are preferably attached to each other in wet state, i.e. wet webs are couched together followed by pressing and drying to form said multilayer barrier film. It has been found that the production of a high barrier film at high production speed is easier achieved if a multilayer barrier film is produced. By the use of thinner layers, and preferably fine fibril depleted material, the dewatering speed of each layer can be increased and the couching of the different layers together will still make it possible to produce a multilayer structure with very good barrier properties, even if each layer per se does not have that good barrier properties

The multilayer barrier film preferably has a geometric mean tensile stiffness of at least 300 kN/m, preferably at least 320 kN/m and even more preferred at least 350 kN/m. This is preferably the value of the multilayer barrier film before addition of any eventual polymer layers. It has been found that increased tensile stiffness will provide for a stronger barrier film that will withstand converting, e.g. folding, creasing and handling in converting machines, and mechanical process steps in an improved way. It has also been found that the use of the multilayer barrier film with improved tensile stiffness in a paper or paperboard based packaging material makes it possible to reduce the amount of fibers in the final material, i.e. it enables source reduction of the final packaging material. Furthermore, the improved tensile stiffness enables the use of recycled pulp or use of a higher amount of broke pulp to be used. The tensile stiffness is measured according to standard SCAN-P 67. The geometric mean tensile stiffness is calculated based on the tensile stiffness in MD and CD according to (MD×CD)^{1/2}.

It is preferred that the bursting strength of the film is at least 130 kPa, preferably at least 140 kPa and even more preferred at least 150 kPa measured according to ISO 2759. This is preferably the value of the multilayer barrier film before addition of any eventual polymer layers. The bursting strength of the film is an important feature which makes the converting and handling of the barrier film easier without rupturing or damaging the film and thus destroying the barrier properties of the film.

It is preferred that more than 95% by weight of the multilayer barrier film is cellulose based. This is the amount of cellulose in the barrier film before addition of any eventual polymer layers. Consequently, the barrier film of the present invention is manly cellulose based. In this way a sustainable and renewable barrier film is produced which can be used to replace fossil-based barrier materials or aluminum foil. Using a cellulose based barrier film is especially useful for use in paper or paperboard laminates since the laminate can be recycled as a single material.

The inventive multilayer barrier film may preferably be used as a barrier layer in a paper or paperboard based packaging material, particularly in packaging board, liquid packaging board (LPB), paper pouches or paper or paperboard tubes or cups, for use in the packaging of liquids or liquid containing products. Therefore, according to a second aspect illustrated herein, there is provided a paper or paperboard based packaging material comprising a paper or paperboard base layer; and a multilayer barrier film as described herein. It has been found that the multilayer barrier film according to the present invention is an excellent barrier and can be used as a sustainable barrier instead of polymer or aluminum-foil layers.

The multilayer barrier film of the paper or paperboard based packaging material according to the second aspect may be further defined as set out above with reference to the first aspect.

Paper generally refers to a material manufactured in thin sheets from the pulp of wood or other fibrous substances comprising cellulose fibers, used for writing, drawing, or printing on, or as packaging material. With paper base layer is meant the cellulosic paper layer of a paper packaging material.

Paperboard generally refers to strong, thick paper or cardboard comprising cellulose fibers used for boxes and other types of packaging. Paperboard can either be bleached or unbleached, coated or uncoated, and produced in a variety of thicknesses, depending on the end use requirements. With paperboard base layer is meant the cellulosic paperboard layer of the paperboard based packaging material.

A paper or paperboard-based packaging material is a packaging material formed mainly, or entirely from paper or paperboard. In addition to paper or paperboard, the paper or paperboard-based packaging material may comprise additional layers or coatings designed to improve the performance and/or appearance of the packaging material.

In some embodiments, the multilayer barrier film is laminated onto the base layer using an adhesive polymer layer disposed between the base layer and the barrier film. Thus, in some embodiments the paper or paperboard based packaging material further comprises an adhesive polymer layer, e.g. a tie layer, disposed between the base layer and the barrier film.

The inventive multilayer barrier film or the paper or paperboard based packaging material is preferably realized without any extrusion coated or lamination coated polyolefin coatings often used in barrier layers for liquid packaging materials. Instead, the inventive barrier film preferably uses materials, which enables easier recycling and that are more easily separated from the from the fibrous paper and paperboard materials and thereby facilitates re-pulping of the board. However, it is of course also possible to combine the inventive barrier film with a conventional extrusion coated or lamination coated polyolefin coating layer.

The paper or paperboard preferably has a basis weight in the range of 20-500 gsm, preferably in the range of 80-400 gsm and it preferably has a density between 350-850 kg/m³ measured according to ISO 534.

The paper or paperboard based packaging material may further comprise at least one outer polymer layer. The outer polymer layer may of course interfere with repulpability, but may still be required or desired in some applications. The outer polymer layer may for example be applied by extrusion coating, film lamination or dispersion coating in one or several steps. The outer polymer layer can be a coating layer to improve the barrier properties and to give the barrier film heat-sealing properties. The outer polymer layer may also be a tie layer used to improve the adhesion of the barrier film to another substrate, such as a paper or paperboard substrate. The polymer layer is preferably applied to the surface of the barrier film so that a coated paper or paperboard based packaging layer is formed.

It is preferred that that the barrier film is located between the paper or paperboard base layer and the outer polymer layer of said coated paper or paperboard based packaging material. The other side of the paper or paperboard base layer not in contact with the barrier film may also be polymer coated with an outer polymer layer to provide the paper or paperboard based packaging material with additional barrier, printing and heat-sealable properties.

The outer polymer layer may comprise any of the thermoplastic polymers commonly used in paper or paperboard based packaging materials in general or polymers used in liquid packaging board in particular. Examples include polyethylene (PE), polyethylene terephthalate (PET), polypropylene (PP), polyhydroxyalkanoates (PHA), polylactic acid (PLA), polybutylene succinate (PBS), polyethylene furanoate (PEF), polyvinyl alcohol (PVOH), acrylates, styrene/butadiene, polyvinyl acetate, or polyglycolic acid (PGA). Polyethylenes, especially low density polyethylene (LDPE) and high density polyethylene (HDPE), are the most common and versatile polymers used in liquid packaging board.

The basis weight of the outer polymer layer is preferably less than 40 gsm. In order to achieve a continuous and substantially defect free film, a basis weight of the polymer layer of at least 5 gsm, preferably at least 10. In some embodiments, the basis weight of the polymer layer is in the range of 5-40 gsm, preferably in the range of 5-20 gsm, preferably between 10-15 gsm.

The paper or paperboard based packaging material may further comprise a metallized or vacuum deposited metal or metal oxide layer, preferably applied by physical vapor deposition (PVD) or chemical vapor deposition (CVD). The metallized layer preferably comprises a metal or metal oxide selected from the group consisting of aluminum, magnesium, silicon, copper, aluminum oxides, magnesium oxides, silicon oxides, and combinations thereof, preferably aluminum.

Generally, while the products, polymers, materials, layers and processes are described in terms of “comprising” various components or steps, the products, polymers, materials, layers and processes can also “consist essentially of” or “consist of” the various components and steps.

According to a third aspect illustrated herein, there is provided a method for manufacturing a multilayer barrier film for a paper or paperboard based packaging material, comprising the steps of:
a) providing a first furnish comprising at least 70 wt-% of highly refined cellulose based on the total fiber content of the first furnish,
b) applying said first furnish to a first substrate,
c) dewatering said first furnish on said first substrate to form a first wet web,
d) providing a second furnish comprising cellulosic fibers and less than 50 wt-% of highly refined cellulose based on the total fiber content second furnish,
e) applying said second furnish to a second substrate,
f) dewatering said second furnish on said second substrate to form a second wet web,
g) applying said second wet web onto said first wet web forming a multilayer web,
h) drying and optionally pressing said multilayer web to form a multilayer barrier film
wherein the first web forms the top side of the barrier film and the second web forms the bottom side of the barrier film and said multilayer barrier film has an air permeance below 1000 pm/Pas and a tear index GM above 4.5.

The barrier film according to the third aspect may be further defined as set out above with reference to the first aspect.

The second suspension preferably has a dewatering time below 100 s/g. It has been found that it is possible to use a furnish with very good dewatering properties and still be able to produce a multilayer film with good barrier properties. The low dewatering time will facilitate dewatering which makes it possible to increase the production speed.

The method further comprises the step of applying a polymer layer to at least one side of the multilayer barrier film to form a coated multilayer barrier film. It is preferred that the polymer layer is applied onto the top side of the multilayer barrier film. The polymer layer may be applied by any known method, such as extrusion or lamination. It is preferred that the polymer layer is a water soluble polymer, preferably polyvinyl alcohol (PVOH), polyurethane, styrene polyacrylates, ethylene acrylic acid, polysaccharides such as starch, starch alignate, hemicellulose, chitosan, cellulose or derivatives of mentioned polysaccharides and mentioned polymers.

The coated multilayer barrier film preferably has an oxygen transmission rate (OTR), measured according to the standard ASTM F1927-20 at 50% relative humidity and 23° C., of less than 5 cc/m²/24 h, preferably below 3 cc/m²/24 h and even more preferred below 1 cc/m²/24 h.

The drying and optionally pressing on the multilayer barrier film, before and/or after coating can be done by any known used equipment. Drying may for example be done by passing the web around a series of heated drying cylinders. Drying may typically remove the water content down to a level of about 1-15 wt %, preferably to about 2-10 wt %. Pressing such as calendaring may be done in any suitable pressing equipment either before or after coating of said multilayer barrier film.

The substrate may be a non-porous substrate or a porous substrate. The use of non-porous substrates, such as polymer or metal substrate is normally used in formation of the barrier film by use of casting technologies, followed by drying with evaporation. Alternatively, the film can be made by applying a suspension on a porous substrate forming a web followed by dewatering of the web by draining water through the substrate for forming the film. The porous substrate may for example be a membrane or wire fabric. Formation of the multilayer barrier film can be accomplished e.g. by use of a paper- or paperboard machine type of process.

The weight ratio between the first web and the second web is preferably from 30:70 to 70:30, even more preferred between 40:60 to 60:40. The multilayer barrier film may be symmetrical, i.e. having a weight ratio of 50:50 or non-symmetrical meaning that the weight ratio is different between the two webs. A non-symmetrical structure can be designed to reduce problems with e.g. curl of the final dried product. It has been found that the production of a high barrier film at high production speed is easier achieved if a multilayer barrier film is produced.

The multilayer barrier film is preferably produced at a production speed of at least 300 m/min, preferably at least 400 m/min or even more preferred at least 500 m/min, preferably at a production speed between 400-1400 m/min.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

### EXAMPLES

### Experimental

In the examples below, a 2-ply barrier film was made on a pilot machine using two head boxes with two separate wire and dewatering system, thus resembling fourdrinier technology. The pilot machine has forming section, following press section, drying section and finally machine calander and winding station.

The pulp used in the examples was hardwood bleached kraft pulp (birch) refined to °SR 30.

The highly refined cellulose (HRC) was obtained through refining bleached kraft pulp to °SR 94-96 and was used as never-dried.

The samples were coated with polyvinyl alcohol (Poval 15-99, Kuraray) with rod coated and coat weight of 3 gsm.

### Example 1—Comparative, Single Ply 100% Highly Refined Cellulose

A single ply 40 gsm web made from a furnish comprising 100% highly refined celluose was made. The dewatering time of the furnish was very high 230 s/g which make it very difficult to dewater the furnish and produce said film. The film showed good strength properties and oxygen barrier properties.

### Example 2—Comparative, Multilayer Barrier Film

In this example, a 2-ply barrier film was made on the pilot PM using a furnish comprising 100% highly refined cellulose in the top and back ply, respectively. The furnish had a high dewatering time at 224 s/g. The air permeance of the film has increased but it was still possible to coat the film and get very good oxygen barrier properties. However, the dewatering time of the furnish was very high so the production speed of this film is too slow.

### Example 3-Multilayer Barrier Film with Highly Refined Cellulose and Birch Cellulosic Fibers in Back Ply, Asymmetrical—According to the Invention

The amount highly refined cellulose was reduced in the back ply to 30%, whereas the top layer was kept the same, i.e. comprising 100% highly refined cellulose. The furnish of the second layer had a dewatering time of 43 s/g, consequently the dewatering time and production speed is improved.

The formed multi-ply barrier film has very good strength properties with a high tear index value. The air permeance value is higher which indicates that the barrier properties of the film have decreased. However, by application of a small amount of polymer a coated multilayer barrier film is produced having excellent barrier properties.

### Example 4—Comparative-Multilayer Barrier Film with Highly Refined Cellulose and Birch Cellulosic Fibers in Top and Back-Ply, Symmetrical

In this example, the amount of highly refined cellulose in both the first layer and the second layer was about 70 wt %. The furnish had a dewatering time of 96 s/g. The film had worse air permeance, which increased significantly, and the strength properties were also not as good as the example according to the invention.

### Example 5—Coating

All base materials were coated on the top side or on the back side. As seen from the results, very low OTR (good gas barrier) values were obtained, especially when the coating was applied on the top side of the films.

These results further confirm that a high drainage multilayer recipe and base can be created and by applying a thin polymer coating, preferably to the dense side, i.e. top side of the film a film with excellent barrier properties can be formed.

### Methods

| | |
|---|---|
| Grammage | ISO 536 |
| Density, single sheet | ISO 534 |
| Tensile strength | ISO 1924-3 |
| Tensile stiffness | ISO 1924-3 |
| Tensile stiffness index | ISO 1924-3 |
| Tensile stiffness GM | ISO 1924-3 |
| Tearing resistance | ISO 1974 |
| Burst index | ISO 2759 |
| Air permeance | ISO 5636-1 |

TABLE I

| | | 1 | 2 | 3 | 4 |
|---|---|---|---|---|---|
| Top ply - Target gsm | gsm | 40 | 20 | 20 | 20 |
| HRC | % | 100 | 100 | 100 | 70 |
| Birch SR 30 | % | | | | 30 |
| | % | | | | |
| Bottom ply - Target gsm | gsm | | 20 | 20 | 20 |
| HRC | % | | 100 | 30 | 70 |
| Birch SR 30 | % | | | 70 | 30 |
| 3 rd press solids | % | | | 28.9 | |

TABLE II

| | | 1 | 2 | 3 | 4 |
|---|---|---|---|---|---|
| Grammage | Gsm | 35.7 | 39.1 | 41.2 | 40 |
| Thickness, single sheet | μm | 44 | 59 | 54 | 55 |
| Density, single sheet | kg/m³ | 814 | 666 | 771 | 725 |
| Tensile stiffness GM | kN/m | 307.27 | 311.57 | 312.57 | 313.62 |
| Tear index, md | mNm²/g | 3.9 | 4.2 | 5.4 | 4.9 |
| Tear index, cd | mNm²/g | 4.4 | 4.2 | 5 | 4.4 |
| Tear index, GM | | 4.1 | 4.2 | 5.2 | 4.6 |
| Bursting strength | kPa | 134 | 112 | 134 | 120 |
| Air permeance, ts | pm/Pas | 3.5 | 986.1 | 1267.5 | 7627 |
| Air permeance, bs | pm/Pas | 6.4 | 375.9 | 2000.3 | 7755 |

TABLE III
OTR Results after coating

| | | 1 | 2 | 3 | 4 |
|---|---|---|---|---|---|
| OTR 23 C./ 50% RH - coating | cc/m2/24 h | 0.3 | 0.1 | 0.1 | 0.6 |
| on top side | | | | | |
| OTR 23 C./ 50% RH - coating | cc/m2/24 h | 0.1 | 0.2 | 326 | 430 |
| on back side | | | | | |

1. A multilayer barrier film for a paper or paperboard packaging material, said barrier film comprises
a first layer comprising a furnish comprising at least 70 wt-% of highly refined cellulose based on a total fiber content of the first layer,
a second layer comprising a furnish comprising cellulosic fibers and less than 50 wt-% of highly refined cellulose based on a total fiber content of the second layer,
wherein the multilayer barrier film has an air permeance above 1,000 pm/Pas and a tear index GM above 4.5.

2. The multilayer barrier film according to claim 1, wherein the barrier film further comprises a third layer wherein said third layer comprises a polymer.

3. The multilayer barrier film according to claim 2, wherein the polymer layer comprises polyvinyl alcohol (PVOH), polyurethane, styrene polyacrylates, ethylene acrylic acid, polysaccharides, starch, starch alignate, hemicellulose, chitosan, cellulose, or derivatives of any of the foregoing.

4. The multilayer barrier film according to claim 2, wherein the third layer is coated onto said first layer.

5. The multilayer barrier film according to claim 2, wherein the coated barrier film has an oxygen transmission rate (OTR), measured according to standard ASTM F1927-20 at 50% relative humidity and 23° C., of less than 5 cc/m²/24 h.

6. The multilayer barrier film according to claim 2, wherein a grammage of the third polymer layer is below 15 gsm.

7. The multilayer barrier film according to claim 1, wherein the second layer of the barrier film comprises between 5-50 wt-% of highly refined cellulose based on the total fiber content of the second layer.

8. The multilayer barrier film according to claim 1, wherein the second layer of the barrier film comprises between 50-95 wt-% of cellulosic fibers based on the total fiber content of the second layer.

9. The multilayer barrier film according to claim 1, wherein the cellulosic fibers has a Schopper Riegler value between 15-45, as determined by standard ISO 5267-1.

10. The multilayer barrier film according to claim 1, wherein the furnish of the second layer has a dewatering time below 100 s/g.

11. The multilayer barrier film according to claim 1, wherein the second layer comprises 5-70 wt-% of broke based on the total fiber content of the furnish of the second layer.

12. The multilayer barrier film according to claim 1, wherein the first layer of the barrier film comprises between 70-100 wt-% of highly refined cellulose based on the total fiber content of the first layer.

13. The multilayer barrier film according to claim 1, wherein the highly refined cellulose has a Schopper Riegler value above 70, as determined by standard ISO 5267-1.

14. The multilayer barrier film according to claim 1, wherein the highly refined cellulose is comprises microfibrillated cellulose (MFC).

15. The multilayer barrier film according to claim 1, wherein the barrier film has a basis weight between 20-120 gsm.

16. The multilayer barrier film according to claim 1, wherein the barrier film has a geometric mean tensile stiffness of at least 300 kN/m.

17. A paper or paperboard based packaging material comprising:
a paper or paperboard base layer; and
the barrier film according to claim 1.

18. The paper or paperboard based packaging material according to claim 17, wherein the paper or paperboard has a basis weight in a range of 20-500 gsm.

19. (canceled)

20. (canceled)

21. (canceled)

22. (canceled)

23. (canceled)
